(19) United States
(12) Patent Application Publication
(10) Pub. No.: US 2026/0065424 A1
(43) Pub. Date: Mar. 5, 2026

(54) ADAPTIVE DISPLAY BUFFERING SYSTEM, METHOD, AND MEDIUM FOR ENHANCED VISUAL COMFORT

(71) Applicant: NANTONG NUOTONG YIMU MEDICAL TECHNOLOGY CO., LTD., Nantong (CN)

(72) Inventors: Xiaogu CAI, Nantong (CN); Make DI, Nantong (CN); Puer`AJINKA JIEDIPUXINGE, Pune (IN); Pateerhaina SINEIHAER`, Surat (IN); Pachade SAMIKSHA, Amravati (IN); Krishnakant Railkar SOHAM, Dahanu (IN)

(21) Appl. No.: 19/386,562

(22) Filed: Nov. 12, 2025

Related U.S. Application Data
(63) Continuation of application No. PCT/CN2025/116099, filed on Aug. 21, 2025.

(30) Foreign Application Priority Data
Jul. 18, 2025 (CN) 202510993332.2

(51) Int. Cl. G06T 5/20; G06F 3/01; G06T 5/40; G06T 5/70; G06V 10/77

(52) U.S. Cl. CPC G06T 5/20; G06F 3/013; G06T 5/40; G06T 5/70; G06V 10/7715

(57) ABSTRACT

An adaptive display buffering method for enhanced visual comfort includes: original display data is obtained from an off-screen display buffer; an encoded vector is generated based on the original display data, and content feature scoring is performed based on the encoded vector; content features of the original display data are modified based on the content feature scoring and a user gaze direction, and a content regulator applies different modification methods to a foveal region and a peripheral region; and modified display data is stored into an on-screen display buffer. An adaptive display buffering system for enhanced visual comfort is also provided.

### CROSS-REFERENCE TO RELATED APPLICATIONS

This application is a continuation of International Patent Application No. PCT/CN2025/116099, filed on Aug. 21, 2025, which claims the benefit of priority from Chinese Patent Application No. 202510993332.2, filed on Jul. 18, 2025. The content of the aforementioned application, including any intervening amendments made thereto, is incorporated herein by reference in its entirety.

### TECHNICAL FIELD

This application relates to display technology, and more particularly to an adaptive display buffering system, method, and medium for enhanced visual comfort.

### BACKGROUND

Display systems have become an integral part of modern life, with users spending considerable time viewing content across various devices such as computers, smartphones, tablets, and virtual reality headsets. While these display devices significantly enhance our access to information and entertainment, prolonged usage may lead to visual discomfort and fatigue. Traditional display systems typically present content without adequate consideration of user comfort or potential long-term visual effects. Their static characteristics fail to meet the dynamic nature of the human visual system, which has evolved to process central and peripheral visual information differently.

Moreover, the increasing adoption of high-resolution displays and immersive technologies introduces new challenges in managing visual comfort. Users may experience eye strain or headaches during extended viewing sessions, particularly under poor lighting conditions or during late-night device usage.

While image processing has made substantial advances in improving visual quality, less attention has been directed toward optimizing content for enhanced visual comfort. Although some systems employ basic techniques such as blue light filtering or brightness adjustment, more sophisticated approaches are needed to dynamically adapt to individual user needs and viewing conditions. Furthermore, growing concerns about the potential impact of prolonged screen use on visual health-particularly among children and young adults-highlight the importance of developing display technologies that not only deliver high-quality visual experiences but also prioritize long-term ocular health.

As display technology continues to evolve and become more deeply integrated in daily life, there is an increasing need for innovative solutions that balance visual quality, user comfort, and potential health considerations. These advancements could have profound impact across multiple domains, including education, entertainment, and professional environments involving extended screen use.

### SUMMARY

In view of the deficiencies in the prior art, this application provides an adaptive display buffering system, method, and medium for enhanced visual comfort.

Technical solutions of the present disclosure are described as follows.

In a first aspect, this application provides an adaptive display buffering system for enhanced visual comfort, comprising:
an off-screen display buffer;
a content analysis module;
a gaze estimation module;
a content regulator; and
an on-screen display buffer;
wherein the off-screen display buffer is configured to store original display data;
the content analysis module comprises a feature encoder and a scoring submodule, the feature encoder is configured to generate an encoded vector based on the original display data, and the scoring submodule is configured to perform content feature scoring based on the encoded vector;
the gaze estimation module is configured to determine a user gaze direction;
the content regulator is configured to modify content features of the original display data based on the content feature scoring and the user gaze direction, and the content regulator applies different modification methods to a foveal region and a peripheral region; and
the on-screen display buffer is configured to store modified display data.

In an embodiment, step for generating the encoded vector based on the original display data comprises extracting the content features using domain-specific filters or layers.

In an embodiment, step for analyzing the encoded vector to generate content feature scores comprises scoring different content features separately through different scoring submodules; wherein during content feature scoring, weights of the different content features are determined based on impacts on visual comfort, with primary content features analyzed first and secondary content features analyzed subsequently when necessary.

In an embodiment, the content features comprise luminance distribution, contrast distribution, color distribution, and spatial frequency distribution.

In an embodiment, the adaptive display buffering system further comprises a user feedback loop module configured to collect and input user feedback to the content regulator for optimizing an adjustment process of the content features based on the user feedback.

In a second aspect, this application provides an adaptive display buffering method for enhanced visual comfort, comprising:
obtaining original display data from an off-screen display buffer;
generating an encoded vector based on the original display data and performing content feature scoring based on the encoded vector;
modifying content features of the original display data based on the content feature scoring and a user gaze direction, wherein the content regulator applies different modification methods to a foveal region and a peripheral region; and
storing modified display data into the on-screen display buffer.

In an embodiment, step for generating the encoded vector based on the original display data comprises extracting the content features using domain-specific filters or layers.

In an embodiment, step for analyzing the encoded vector to generate content feature scores comprises scoring different content features separately through different scoring submodules; and during content feature scoring, weights of the different content features are determined based on impacts on visual comfort, with primary content features analyzed first and secondary content features analyzed subsequently when necessary.

In an embodiment, the adaptive display buffering method further comprising collecting and inputting user feedback to the content regulator for optimizing an adjustment process of the content features based on the user feedback.

In a third aspect, this application provides a computer-readable storage medium storing program instructions, wherein when executed by at least one processor, the program instructions implement the adaptive display buffering method described herein.

Compared to the prior art, the present disclosure has the following beneficial effects.

The present disclosure enhances visual comfort, implements intelligent rendering technology, and alleviates vision-related health issues. Additionally, the present disclosure provides the following advantages.
1. Personalized visual experience: by integrating user feedback and gaze information, the system delivers a customized visual experience tailored to individual needs and preferences.
2. Enhanced extended reality (XR) device performance: Foveated rendering capability significantly reduces computational demands in virtual reality (VR), augmented reality (AR), and mixed reality (MR) applications without compromising perceived quality.
3. Potential health benefits: the system's ability to modulate visual stimuli, particularly in the peripheral visual field, may contribute to ocular health by potentially slowing myopia progression or reducing eye strain.
4. Adaptability to diverse content types: comprehensive content analysis enables the system to apply appropriate modifications to various content types, ranging from text documents to dynamic video.
5. Real-time processing: by utilizing feature encoders for information compression, the system performs complex analysis and modulation in real time, ensuring a responsive user experience.

### BRIEF DESCRIPTION OF THE DRAWINGS

The present disclosure will be further described in detail below in conjunction with the accompanying drawings and embodiments to understand the above objects, features and advantages of the present disclosure more clearly. The scope of the disclosure is not limited by the embodiments disclosed below.

FIG. 1 is a schematic diagram of an adaptive display buffering system according to an embodiment of the present disclosure;

FIG. 2 is a diagram showing cooperative relationships between various modules according to an embodiment of the present disclosure; and

FIG. 3 is a flowchart of an adaptive display buffering method according to an embodiment of the present disclosure.

### DETAILED DESCRIPTION OF EMBODIMENTS

The present disclosure will be described below in detail with reference to specific embodiments to facilitate the understanding of the present disclosure. The scope of the disclosure is not limited by the embodiments disclosed below. It should be understood that any modifications and replacements made by those skilled in the art without departing from the spirit of the disclosure should fall within the scope of the disclosure defined by the appended claims.

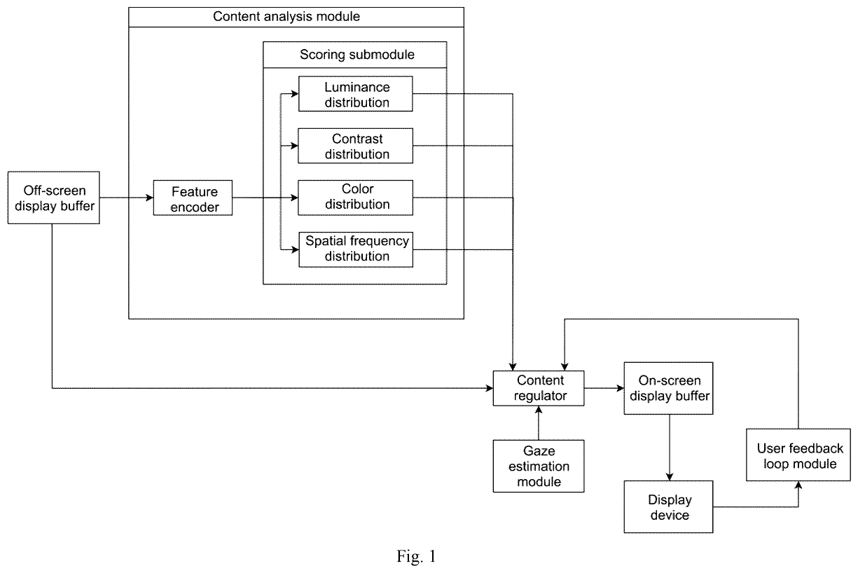

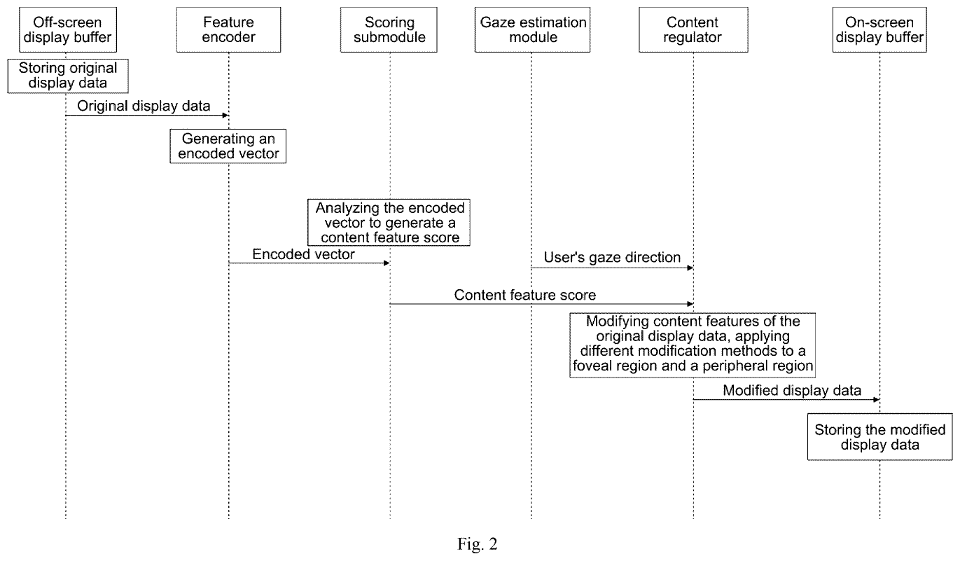

As shown in FIGS. 1 and 2, the present disclosure provides an adaptive display buffering system for enhanced visual comfort. The adaptive display buffering system includes an off-screen display buffer, a content analysis module, a gaze estimation module, a content regulator, and an on-screen display buffer.

The off-screen display buffer is configured to store original display data. The off-screen display buffer contains original image or video data prior to the comfort-enhancing modifications. The video data is constituted by the image data of each frame. The original display data may include, but is not limited to, pixel values, color information, and other relevant data associated with the content to be displayed.

The content analysis module includes a feature encoder and a scoring submodule that collaborate to analyze the original display data and generate content feature scores.

The feature encoder is configured to take the original display data from the off-screen display buffer as input and output the encoded vector. This process may compress the information within the frame to enable faster analysis and processing. The feature encoder may utilize convolutional neural networks or other machine learning methods to efficiently extract relevant features from the input data.

The feature encoder is specifically designed to extract task-relevant features such as luminance, contrast, color, and spatial frequency-using domain-specific filters or layers. For instance, for luminance distribution feature extraction, a luminance convolution kernel Kₗ(m, n) is designed to highlight differences between regions of varying brightness. Its element values are set according to the mathematical characteristics of luminance features. For example, different weights are assigned to the center pixel and its surrounding pixels to enhance sensitivity to luminance variations. For contrast distribution feature extraction, the mean contrast μ_{I} of the image is first calculated. The contrast convolution kernel K_{c}(m, n) is then designed to emphasize regions of the image with significant deviations from the mean, thereby extracting contrast features. For color distribution feature extraction, the color convolution kernel Kₛ(m, n) is designed based on color space conversion principles to extract relational features between different color channels. For spatial frequency distribution feature extraction, the frequency convolution kernel K_{f}(m, n) is designed by applying the Fourier transform correlation principles, enabling it to capture information about different frequency components within the image. Here, m and n represent offset values.

The original display data I(x, y) is input to perform convolution operations through domain-specific convolution kernels, thereby obtaining a luminance distribution feature map L(x, y), a color distribution feature map S(x, y), a spatial frequency distribution feature map F(x, y), and a contrast distribution feature map C(x, y), which are expressed as:

$$L ( x , y ) = {\sum }_{m} {\sum }_{n} I ( x + m , y + n ) {K}_{l} ( m , n ) ;$$

$$S ( x , y ) = {\sum }_{m} {\sum }_{n} I ( x + m , y + n ) {K}_{s} ( m , n ) ;$$

$$F ( x , y ) = {\sum }_{m} {\sum }_{n} I ( x + m , y + n ) {K}_{f} ( m , n ) ; and$$

$$C ( x , y ) = {\sum }_{m} {\sum }_{n} ( I ( x + m , y + n ) - {μ}_{I} ) {K}_{c} ( m , n ) .$$

Then, the feature maps of each frame are combined into the encoded vector.

This ensures that the encoded latent vector is optimized for direct use in the scoring module, minimizing additional preprocessing and improving efficiency.

The scoring submodule generates encoded vectors based on the original display data. The scoring submodule is configured to perform content feature scoring based on the encoded vectors. This module may include multiple submodules, each responsible for analyzing and scoring specific aspects of the content. These submodules may be implemented using arithmetic functions, machine learning models, or neural networks. They may take the encoded vector or latent vector as input and output score values for various content features. These content features may include, but are not limited to, luminance (luminance distribution), contrast (contrast distribution), color (color distribution), and spatial frequency (spatial frequency distribution). The scores provided by these submodules may serve as input for the content regulator to make content modification decisions.

The scoring process is designed to ensure effective and rapid adjustments by the content regulator.

Parameter prioritization and weights: a weighted scoring system is used to prioritize key parameters (e.g., luminance, contrast) based on their impact on visual comfort. Less key parameters are assigned lower weights, thereby reducing the computational burden. Content scoring is implemented through a hierarchical process, primary parameters (e.g., luminance and contrast) are analyzed first for immediate adjustments, while secondary parameters (e.g., spatial frequency) are analyzed subsequently only when necessary.

The scoring submodule employs Principal Component Analysis (PCA) or similar techniques to reduce the complexity of the latent vectors, ensuring faster computation without significant information loss. Adaptive scoring thresholds enable the content regulator to focus solely on parameters exceeding specific predefined thresholds, ignoring negligible variations. A parallel processing framework is adopted, enabling the simultaneous scoring of multiple parameters, which significantly reduces latency and ensures real-time content adjustment.

The gaze estimation module is configured to determine the user's gaze direction. This module may be configured to determine the user's current gaze direction. In some implementations, the gaze estimation module may utilize eye-tracking hardware or software-based gaze estimation techniques. Gaze information may be used to distinguish between the user's foveal (central) and peripheral visual fields, thereby enabling targeted content modulation. In some scenarios, the gaze estimation module determines the user's current gaze direction, which is critical for identifying Areas of Interest (AOI) within the display.

The content regulator is configured to modify the content features of the original display data based on content feature scores and the user gaze direction. The content regulator applies different modification methods to content displayed the foveal region and the peripheral region. These modifications may be based on the scores provided by the content analysis module and the gaze information provided by the gaze estimation module. The content regulator may modify various content parameters, including luminance (luminance distribution), contrast (contrast distribution), color (color distribution), and spatial frequency (spatial frequency distribution). In some cases, the modifications applied to the foveal region may differ in intensity or type from those applied to the peripheral region. This capability of applying distinct modifications to different regions of the displayed content based on the user gaze direction enables advanced techniques such as foveated rendering. These modifications enhance visual comfort, enable advanced rendering techniques, and may alleviate vision-related health issues.

The content regulator directly applies parameter modifications to the original image data within the foveal region corresponding to the Region of Interest (ROI) and the peripheral region (non-ROI) based on real-time scoring. The luminance, contrast, spatial frequency, and color are dynamically adjusted across both regions, ensuring seamless transitions while preserving content fidelity. Modifications in the foveal region are precisely focused to achieve high-level details (e.g., sharpness, color enhancement). Adjustments in the peripheral region are designed with energy efficiency and reduced processing load in mind, exemplified by techniques such as subtle blurring or brightness dimming. This process is guided by content scoring outputs (e.g., luminance levels or gaze heatmaps) to dynamically prioritize parameters requiring adjustment, ensuring personalization and resource efficiency.

The modifications by the content regulator to the foveal region may differ in intensity or type from those applied to the peripheral region. This capability of applying distinct modifications to different regions of the displayed content based on the user gaze direction enables advanced techniques such as foveated rendering, where image quality or features can be selectively adjusted to match the capabilities of the human visual system. This approach may improve the user's overall visual comfort during prolonged viewing sessions, reduce eye strain and fatigue, and potentially contribute to ocular health by slowing myopia progression or alleviating ocular fatigue.

For instance, in the foveal region, the histogram equalization algorithm is used to enhance image details. Given an original image pixel value is p, the pixel value q after histogram equalization is calculated as:

$$q = \frac{L - 1}{N} {\sum }_{i = 0}^{p} {n}_{i} .$$

In above formula, L is a total number of image grayscale levels, N is a total number of image pixels, and nᵢ is the number of pixels with grayscale level i. For peripheral regions, blur processing is performed by Gaussian blurring algorithm. The original display data I(x, y) becomes I′(x, y) after Gaussian blurring, which is expressed as:

$${I}^{′} ( x , y ) = \frac{1}{2 {πσ}^{2}} {\sum }_{m} {\sum }_{n} I ( x + m , y + n ) {e}^{-} \frac{{m}^{2} + {n}^{2}}{2 {σ}^{2}} .$$

In above formula, σ is the standard deviation of Gaussian kernel, adjusted based on visual characteristics of the peripheral regions; e is the natural constant. As the surrounding pixel's position (defined by smaller values of m and n) gets closer to the current pixel, the term

$${e}^{-} \frac{{m}^{2} + {n}^{2}}{2 {σ}^{2}}$$

approaches 1, resulting in a greater weight assigned to that pixel during the blurring operation. Conversely, pixels farther from the current pixel (with larger m and n values) receive smaller weights. This reflects the characteristics of Gaussian blur that performs the weighted sum of surrounding pixels with different weights assigned according to their distances. This behavior aligns with human visual perception on the blur sensitivity in the peripheral regions.

In some scenarios, the content regulator may detect that the overall brightness of the content is too high for comfortable viewing, particularly in low-light environments. The content regulator may then reduce the brightness in the peripheral regions more significantly than in the foveal region. This preserves details where the user focuses while mitigating discomfort potentially caused by bright peripheral regions. In other scenarios, the content regulator may identify low-contrast regions within the foveal region that are critical for content comprehension. The content regulator can selectively enhance the contrast in these regions while maintaining the peripheral regions unchanged, thereby improving readability without affecting the overall perceived brightness of the display. In certain aspects, the system may modulate spatial frequency content, particularly in the peripheral regions, to potentially address myopia progression. This may involve amplifying specific spatial frequencies presumed to have protective effects against myopia progression, while ensuring the foveal region retains the high visual quality required for the current task. This capability of applying different modifications to different regions of the displaying content based on the user gaze direction enables advanced techniques such as foveated rendering, where image quality or features can be selectively adjusted to match the capabilities of the human visual system.

The on-screen display buffer is configured to store the modified display data for presentation on the display device. The on-screen display buffer may receive the modified content from the content regulator and present it on the display device, providing the user with enhanced visual experiences.

In some embodiments, the system may further include a user feedback loop module for collecting user feedback and optimizing the content modulation process based on the collected feedback. This loop may be configured to collect user feedback and optimize the content modulation process accordingly. In certain instances, user feedback may be collected via user interface elements or inferred from physiological responses. The feedback may be utilized to adjust the behavior of the content regulator over time, enabling the system to learn user preferences and visual comfort requirements. This feedback loop may be particularly active during an initial calibration phase, enabling the system to adapt to the user's needs and preferences.

In some embodiments, the user feedback loop module may be connected to the display device, allowing user input to influence the content modulation process. This feedback may subsequently be relayed back to the content regulator, thereby establishing a closed-loop system capable of adapting to user preferences or requirements.

This adaptive display buffering system aims to deliver personalized visual experiences that adapt to individual needs and preferences, potentially enhancing the performance of XR devices and contributing to ocular health. The system's ability to analyze and modify display content in real time ensures responsive user experiences, adapting to diverse content types and viewing conditions.

The system holds several potential applications. The primary objective of the system is to improve the user's overall visual comfort during prolonged viewing sessions. By dynamically adjusting content based on analysis and user gaze, the system can reduce eye strain and fatigue. In the VR device, the AR device, and the MR device, the system enables efficient foveated rendering. This technology allocates more computational resources to render high-quality content in the user's foveal region while reducing detail in peripheral regions, thereby optimizing performance without sacrificing perceived quality. Furthermore, the system may help to mitigate, reverse, prevent, delay, inhibit, or control eye growth and/or refractive conditions of the eye. By carefully modulating the visual stimuli presented to the user, particularly in peripheral vision, the system may potentially influence eye growth patterns.

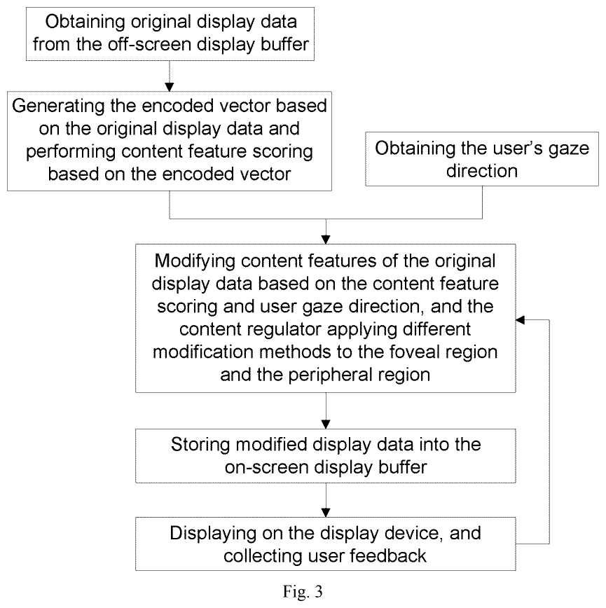

As shown in FIG. 3, the present disclosure further provides an adaptive display buffering method for enhanced visual comfort. The aforementioned adaptive display buffering system for enhanced visual comfort can be implemented by executing the steps of the adaptive display buffering method for enhanced visual comfort. Those skilled in the art may understand the adaptive display buffering method for enhanced visual comfort as a preferred embodiment of the adaptive display buffering system for enhanced visual comfort. The method includes the following steps.

Original display data is obtained from the off-screen display buffer.

The encoded vector is generated based on the original display data, and content feature scoring is performed based on the encoded vector.

The content features of the original display data are modified based on the content feature scoring and the user gaze direction. The content regulator applies different modification methods to a foveal region and a peripheral region.

The modified display data is stored into the on-screen display buffer.

In some embodiments, the method for enhancing visual comfort of displayed content as described above may be implemented in a non-transitory computer-readable storage medium. The medium may store instructions that, when executed by a processor, perform steps for enhancing visual comfort of displayed content. These operation steps may include: receiving original display data from the off-screen display buffer; encoding the original display data to generate the encoded vector and analyzing the encoded vector to produce the content feature score; determining the user's gaze direction; modifying original image data based on the content feature score and the user's gaze direction; and outputting the modified image data into the on-screen display buffer.

### Implementation Examples

### Brightness Adjustment

In one implementation, the system may detect that the overall brightness of the content is too high for comfortable viewing, particularly in low-light environments. The content regulator may reduce the brightness in the peripheral regions more aggressively than in the foveal region, preserving detail where the user focuses while mitigating discomfort potentially caused by bright areas in the peripheral regions.

### Contrast Enhancement

The system may identify low-contrast regions within the foveal region that are important for content comprehension. The content regulator can selectively enhance the contrast in these regions while maintaining the peripheral regions unchanged, thereby improving readability without affecting the overall perceived brightness of the display.

### Color Temperature Adjustment

Based on the time or user preferences, the system can gradually adjust the display's color temperature. The content regulator may apply stronger blue light reduction to the peripheral regions compared to the foveal region, which may help reduce eye strain during nighttime use without significantly impacting color perception in the focal area.

### Spatial Frequency Modulation

To potentially address myopia progression, the system can modulate spatial frequency content, particularly in the peripheral regions. This may involve enhancing certain spatial frequencies hypothesized to offer protective effects against myopia progression, while ensuring the foveal region retains the high visual quality required for the current task.

Those skilled in the art can understand that in addition to implementing the system and its various devices, modules, and units provided by the present disclosure through pure computer-readable program code, the same functionality can be achieved by logically programming the method steps to realize the system and its various devices, modules, and units in forms such as logic gates, switches, application-specific integrated circuits (ASICs), programmable logic controllers (PLCs), and embedded microcontrollers. Consequently, the system and its various devices, modules, and units provided by the present disclosure may be regarded as hardware components, and the devices, modules, and units therein for implementing various functions may also be viewed as structures within the hardware components. Alternatively, the devices, modules, and units for implementing various functions may be regarded as both software modules for implementing methods and structures within the hardware components.

Described above are merely preferred embodiments of the disclosure, which are not intended to limit the disclosure. Those skilled in the art may make various replacements or modifications within the scope of the claims without departing from the spirit of the disclosure. The embodiments and features described herein may be arbitrarily combined with each other in the case of no contradiction.

What is claimed is:

1. An adaptive display buffering system for enhanced visual comfort, comprising:
an off-screen display buffer;
a content analysis module;
a gaze estimation module;
a content regulator; and
an on-screen display buffer;
wherein the off-screen display buffer is configured to store original display data;
the content analysis module comprises a feature encoder and a scoring submodule, the feature encoder is configured to generate an encoded vector based on the original display data, and the scoring submodule is configured to perform content feature scoring based on the encoded vector;
the gaze estimation module is configured to determine a user gaze direction;
the content regulator is configured to modify content features of the original display data based on the content feature scoring and the user gaze direction, and the content regulator applies different modification methods to a foveal region and a peripheral region; and
the on-screen display buffer is configured to store modified display data;
the feature encoder is configured to take original display data I(x, y) as input to perform convolution operations using domain-specific convolution kernels, thereby obtaining a luminance distribution feature map L(x, y), a color distribution feature map S(x, y), a spatial frequency distribution feature map F(x, y), and a contrast distribution feature map C(x, y), which are expressed as:
$$L ( x , y ) = {\sum }_{m} {\sum }_{n} I ( x + m , y + n ) {K}_{l} ( m , n ) ;$$
$$S ( x , y ) = {\sum }_{m} {\sum }_{n} I ( x + m , y + n ) {K}_{s} ( m , n ) ;$$
$$F ( x , y ) = {\sum }_{m} {\sum }_{n} I ( x + m , y + n ) {K}_{f} ( m , n ) ; and$$
$$C ( x , y ) = {\sum }_{m} {\sum }_{n} ( I ( x + m , y + n ) - {μ}_{I} ) {K}_{c} ( m , n ) ;$$
wherein Kₗ(m, n) denotes a luminance convolution kernel, Kₛ(m, n) denotes a color convolution kernel, K_{f}(m, n) denotes a frequency convolution kernel, K_{c}(m, n) denotes a contrast convolution kernel, and m and n represent offset values;
feature maps of each frame are combined into the encoded vector;
the content regulator is configured to perform steps of:
for the foveal region, enhancing image details using a histogram equalization algorithm; wherein an original image pixel value is p, and a pixel value q after histogram equalization is calculated by:
$$q = \frac{L - 1}{N} {\sum }_{i = 0}^{p} {n}_{i} ;$$
wherein L is a total number of image grayscale levels, N is a total number of image pixels, and nᵢ is a number of pixels with grayscale level i; and
for the peripheral region, performing blur processing by Gaussian blurring algorithm; wherein an original display data I(x, y) undergoes the Gaussian blurring to obtain I′(x, y), which is expressed as:
$${I}^{′} ( x , y ) = \frac{1}{2 {πσ}^{2}} {\sum }_{m} {\sum }_{n} I ( x + m , y + n ) {e}^{-} \frac{{m}^{2} + {n}^{2}}{2 {σ}^{2}} ;$$
wherein σ is a standard deviation of a Gaussian kernel, adjusted based on visual characteristics of the peripheral region; e is a natural constant; a position of a surrounding pixel is defined by m and n, as the position of the surrounding pixel gets closer to a current pixel corresponding to smaller m and n values, a term
$${e}^{-} \frac{{m}^{2} + {n}^{2}}{2 {σ}^{2}}$$
approaches 1, resulting in a greater weight assigned to the surrounding pixel during a blurring operation; conversely, the surrounding pixel farther from the current pixel corresponding to larger m and n values receives a smaller weight.

2. The adaptive display buffering system of claim 1, wherein step for generating the encoded vector based on the original display data comprises: extracting the content features using domain-specific filters or layers.

3. The adaptive display buffering system of claim 1, wherein step for analyzing the encoded vector to generate content feature scores comprises:
scoring different content features separately through different scoring submodules;
wherein during content feature scoring, weights of the different content features are determined based on impacts on visual comfort, with primary content features analyzed first and secondary content features analyzed subsequently when necessary.

4. The adaptive display buffering system of claim 1, wherein the content features comprise luminance distribution, contrast distribution, color distribution, and spatial frequency distribution.

5. The adaptive display buffering system of claim 1, further comprising a user feedback loop module configured to collect and input user feedback to the content regulator for optimizing an adjustment process of the content features based on the user feedback.

6. An adaptive display buffering method for enhanced visual comfort, comprising:
obtaining original display data from an off-screen display buffer;
generating an encoded vector based on the original display data and performing content feature scoring based on the encoded vector;
modifying content features of the original display data based on the content feature scoring and a user gaze direction, wherein the content regulator applies different modification methods to a foveal region and a peripheral region;
storing modified display data into an on-screen display buffer;
wherein step for generating the encoded vector comprises:
inputting original display data I(x, y) to perform convolution operations using domain-specific convolution kernels, thereby obtaining a luminance distribution feature map L(x, y), a color distribution feature map S(x, y), a spatial frequency distribution feature map F(x, y), and a contrast distribution feature map C(x, y), which are expressed as:
$$L ( x , y ) = {\sum }_{m} {\sum }_{n} I ( x + m , y + n ) {K}_{l} ( m , n ) ;$$
$$S ( x , y ) = {\sum }_{m} {\sum }_{n} I ( x + m , y + n ) {K}_{s} ( m , n ) ;$$
$$F ( x , y ) = {\sum }_{m} {\sum }_{n} I ( x + m , y + n ) {K}_{f} ( m , n ) ; and$$
$$C ( x , y ) = {\sum }_{m} {\sum }_{n} ( I ( x + m , y + n ) - {μ}_{I} ) {K}_{c} ( m , n ) ;$$
wherein Kₗ(m, n) denotes a luminance convolution kernel, Kₛ(m, n) denotes a color convolution kernel, K_{f}(m, n) denotes a frequency convolution kernel, K_{c}(m, n) denotes a contrast convolution kernel, and m and n represent offset values; and
combining feature maps of each frame into the encoded vector;
the content regulator is configured to perform steps of:
for the foveal region, enhancing image details using a histogram equalization algorithm; wherein an original image pixel value is p, and a pixel value q after histogram equalization is calculated by:
$$q = \frac{L - 1}{N} {\sum }_{i = 0}^{p} {n}_{i}$$
wherein L is a total number of image grayscale levels, N is a total number of image pixels, and nᵢ is a number of pixels with grayscale level i;
for the peripheral region, performing blur processing by a Gaussian blurring algorithm; wherein an original display data I(x, y) undergoes the Gaussian blurring to obtain I′(x, y), which is expressed as:
$${I}^{′} ( x , y ) = \frac{1}{2 {πσ}^{2}} {\sum }_{m} {\sum }_{n} I ( x + m , y + n ) {e}^{-} \frac{{m}^{2} + {n}^{2}}{2 {σ}^{2}} ;$$
wherein σ is a standard deviation of a Gaussian kernel, adjusted based on visual characteristics of the peripheral region; e is a natural constant; a position of a surrounding pixel is defined by m and n, as the position of the surrounding pixel gets closer to a current pixel corresponding to smaller m and n values, a term
$${e}^{-} \frac{{m}^{2} + {n}^{2}}{2 {σ}^{2}}$$
approaches 1, resulting in a greater weight assigned to the surrounding pixel during a blurring operation; conversely, the surrounding pixel farther from the current pixel corresponding to larger m and n values receives a smaller weight.

7. The adaptive display buffering method of claim 6, wherein step for generating the encoded vector based on the original display data comprises: extracting the content features using domain-specific filters or layers.

8. The adaptive display buffering method of claim 6, wherein step for analyzing the encoded vector to generate content feature scores comprises:
scoring different content features separately through different scoring submodules; wherein during content feature scoring, weights of the different content features are determined based on impacts on visual comfort, with primary content features analyzed first and secondary content features analyzed subsequently when necessary.

9. The adaptive display buffering method of claim 6, further comprising: collecting and inputting user feedback to the content regulator for optimizing an adjustment process of the content features based on the user feedback.

10. A computer-readable storage medium storing program instructions, wherein the program instructions are configured to be executed by at least one processor to implement the adaptive display buffering method of claim 6.
